(19) United States
(12) Patent Application Publication
(10) Pub. No.: US 2005/0151424 A1
(43) Pub. Date: Jul. 14, 2005

(54) Device and method for driving a plurality of loads

(76) Inventor: Yoji Hirosue, Kawasaki (JP)

Correspondence Address: ARENT FOX PLLC, 1050 CONNECTICUT AVENUE, N.W., SUITE 400, WASHINGTON, DC, 20036, US

(21) Appl. No.: 10/835,289

(22) Filed: Apr. 30, 2004

(30) Foreign Application Priority Data
Jan. 9, 2004 (JP) 2004-004423

(51) Int. Cl. H02J 1/00

(52) U.S. Cl. 307/11

(57) ABSTRACT

In drive of loads such as cold-cathode tubes used for a back light device of a liquid crystal display, simplification of a composition required for an abnormality detection is given without spoiling detecting accuracy in the abnormality detection. Because of this, a driving device which drives a plurality of loads (ex. Cold-cathode tubes) in sequence includes a driving part which drives each of the loads in sequence by means of time division, and an abnormality detection part which detects abnormality of each of the loads at the time of the drive of each of the loads. The driving device detects abnormality of a load correspondingly to the sequential drive of each of the loads.

### BACKGROUND OF THE INVENTION

1. Field of the Invention

The present invention relates to a driving system of various kinds of loads, for example, a cold-cathode tube in a back light system which is used as a back light source of a transmissive display device of a liquid crystal display and so on. In particular, the present invention relates to a driving device which provides, for example, an abnormality detection function of inverter's loads and so on as a driving source, and a method thereof.

2. Description of the Related Art

A recent liquid crystal display panel is used from data display of a computer and so on to image display of a television receiver, and, in order to cope with the enlargement of a use like this, the high brightness for display meeting the improvement of a high quality of an image, and so on, has been requested. In order to cope with the improvement of high brightness like this, a back light system in which a plurality of cold-cathode tubes are arranged in parallel directly under the back face of a liquid crystal panel is used. In a liquid crystal display panel which forms a large-sized display, a back light system like this is the main current.

A cold-cathode tube which is used in the back light of a liquid crystal display panel has a problem of a life time due to a secular variation, heat deterioration of various kinds of portions, and so on, in respect to fluorescent material and its sealed-in gas, discharge power and so on. In order to prevent an abnormal behavior caused by a characteristic change such as a change of impedance occurring in the last stage of a life time, it is necessary to break a high-tension circuit in safety. Hence, fault detection and measures based on that fault detection are indispensable.

As an earlier patent document in connection with a back light device like this, for example, the Japanese Patent Laid Open Publication No. 2002-134293 is in existence.

By the way, in a system having a plurality of cold-cathode tubes, in order to diagnose a condition of each cold-cathode tube, detection means which supervises a value such as a tube-current value or a terminal-voltage value of each cold-cathode tube or its fluctuation quantity must be provided at every cold-cathode tube. Like this, to provide the detection means at every cold-cathode tube becomes a cause that a cost is increased and a back light unit is made bigger.

FIG. 1 shows an example of a back light device having a plurality of cold-cathode tubes. This back light device 2 has a cold-cathode tube group 4 composed of a plurality of cold-cathode tubes 401, 402, 403, . . . and 40N and an inverter 6. The inverter 6 has high-tension control circuits 8, boosting transformers 10, capacitors 12 and so on correspondingly to each of the cold-cathode tubes 401, 402, 403, . . . and 40N. Further, current detection circuits 14 which supervise and detect individually a current of each of the cold-cathode tubes 401, 402, 403, . . . and 40N are provided, and a current detected by each current detection circuit 14 is given to a corresponding high-tension control circuit 8 through a corresponding feedback circuit 16, respectively. Like this, in case of a composition in which the current detection circuit 14 and the feedback circuit 16 are provided at every cold-cathode tube 401, 402, 403, . . . or 40N, there is an impropriety that a cost is increased and a back light unit is made bigger.

In connection with the back light device 2 of a composition like this, a composition which detects abnormality by putting individual detection means into one is also considered. For example, a composition shown in FIG. 2 is considered. In this composition, a single current detection circuit 14 is provided to each of cold-cathode tubes 401, 402, 403, . . . and 40N in common, and this composition distributes to each high-tension control circuit 8 by using a feedback circuit 16 in common. According to a composition like this, since wiring of a cold side of the cold-cathode tubes 401, 402, 403, . . . and 40N can be put into one, a space factor for wiring and a cost of a detection circuit can be suppressed. However, in case in which one of the cold-cathode tubes 401, 402, 403, . . . and 40N, for example, the cold-cathode tube 401, shows abnormal in impedance, a variation quantity representative of that condition, namely a current value or its fluctuation quantity, becomes a very small quantity as compared with the whole. Because of this, the decision of normality or abnormality is very difficult, and this causes an erroneous detection and so on. That is, since to use the current detection circuit 14 in common is to lower the accuracy of a current detection, it is not admitted as effective means.

Further, the publication No. 2002-134293 described before presents a problem that, in a back light equipment used for a liquid crystal display panel, when a fluorescence lamp stops lighting up for some reason or other, an unusual rise of an inverter output occurs and there are the dangers of a fire ignition and an electric shock by electric discharge. And, this publication discloses the following composition as solving means. That is, in the back light illumination equipment for liquid crystal displays used for a liquid crystal display panel, when a fluorescence bulb stops lighting by wearing of an electrode in its last stage of a life time or by changing of internal high-pressure gas, or when non-lighting of the fluorescence bulb occurs by escaping of a connector for connecting the fluorescence bulb or by disconnection of a lead wire, the inverter output becomes to a non-load state, and the output voltage rises unusually. To prevent the fire ignition problem by the electric discharge or the electric shock by the contact at the time of repair, lighting or non-lighting of the fluorescence bulb is detected by existence or non-existence of the bulb current. Then, when there is no bulb current namely non-lighting state of the fluorescence bulb, the inverter output is compulsorily stopped to make the unusual rise of the output voltage stop. Even in case of referring to the publication No. 2002-134293 mentioned above, a disclosure of problems of the present invention and solving means thereof are not disclosed or suggested.

### SUMMARY OF THE INVENTION

The present invention relates to drive of loads such as cold-cathode tubes which are used in a back light device of a liquid crystal display, and an object of the present invention is to give simplification of a composition required for an abnormality detection without spoiling the accuracy of a detection in the abnormality detection.

Further, another object of the present invention is to give simplification of a composition of a current detection, when detecting a current of a load and deciding on abnormality, without spoiling the accuracy of a detection.

In order to attain the objects mentioned above, a driving device according to the present invention is a driving device which drives a plurality of loads (cold-cathode tubes 341, 342, 343, . . . and 34N) in sequence, and the driving device is a composition which comprises a driving part (high-tension control parts 361, 362, 363, . . . and 36N, boosting transformers 38) that drives each of the loads in sequence by means of time division, and an abnormality detection part (a current detection part 46, a comparison part 62) that detects abnormality of each of the loads at the time of drive of each of the loads. In this case, abnormality of a load may also be any of a current flowing through a load, an inter-terminal voltage of a load, abnormality in a circuit of a load side, and so on.

According to a composition like this, the plurality of loads such as cold-cathode tubes are driven in order by means of the time division, and abnormality of each of the loads is detected at the time of its drive. That is, since the detection of abnormality is performed synchronously with the drive of a load, independent hardware at every load becomes useless in a process of the detection of abnormality, and a composition for the abnormality detection is to be simplified.

In order to attain the objects mentioned above, the driving device of the present invention may also be constituted so that the above-mentioned abnormality detection part detects a current flowing through each of the loads. According to a composition like this, it is possible to detect abnormality of a load from a current of each load, which is detected synchronously with the sequential drive of the loads by means of the time division. Further, the above-mentioned abnormality detection part may also be constituted so as to decide whether a level of the detected current is normal or abnormal. Further, the above-mentioned abnormality detection part may also be constituted so as to decide on being in badness of behavior in case in which the above-mentioned abnormality is continuously detected for a predetermined time, or in case in which the above-mentioned abnormality is continuously detected the predetermined number of times at detection timing. Furthermore, the above-mentioned loads are not limited to the cold-cathode tubes. The loads may also be a cold-cathode tube inverter which makes the plurality of cold-cathode tubes light up.

In order to attain the objects mentioned above, the driving device of the present invention may also be constituted so that the above-mentioned driving part controls the sequential drive of each of the loads by drive timing, and delays by a predetermined time and drives each of the loads in sequence by means of the drive timing which is generated, and so that the above-mentioned abnormality detection part detects abnormality of each of the loads so as to match with the sequential drive delayed by the predetermined time. Further, the above-mentioned abnormality detection part may also be constituted so as to detect a current of each of the loads by converting into a voltage. Furthermore, the above-mentioned driving device can also drive the plurality of loads at the same time, and the above-mentioned abnormality detection part may also be constituted so as to detect abnormality of each of the loads in case in which the loads are driven in sequence.

In order to attain the objects mentioned above, a driving method according to the present invention is a driving method which drives a plurality of loads in sequence, and this driving method is a composition which comprises a process that drives each of the loads in sequence by means of time division, and a process that detects abnormality of each of the loads at the time of drive of each of the loads. According to a composition like this, abnormality of each load can be detected synchronously with the sequential drive of the loads by means of the time division.

In order to attain the objects mentioned above, the driving method of the present invention may also be constituted so that the above-mentioned process detecting abnormality of each of the loads detects a current flowing through each of the loads. According to a composition like this, abnormality of a load can be detected from a current of each load, which is detected synchronously with the sequential drive of the loads by means of the time division.

As descried above, the present invention relates to a driving system which drives the plurality of loads without limiting to a plurality of cold-cathode tubes, and detects its abnormality synchronously with the time-division drive of each load. Because of this, the present invention can realize an abnormality detection function equivalent to the case in which a composition for detecting abnormality is provided at every load. By this, along with simplification of the composition for detecting abnormality, the present invention can contribute to the improvement of reliability in various kinds of driving systems which drive a plurality of loads, and is useful. Further, enumerating the features and advantages of the present invention, these are as in the following.

(1) In connection with drive of various kinds of loads, for example, a plurality of cold-cathode tubes used in a back light device of a liquid crystal display and soon, it is possible to detect abnormality synchronously with the drive of the plurality of loads by means of the time division. Because of this, without individually providing the composition for detecting abnormality at every load, it is possible to realize detecting accuracy equivalent to the case of individually detecting at every load. Along with this, it is possible to simplify the composition for detecting abnormality or to make this composition singleness.

(2) In relation to a current detection of a plurality of loads, for example, a plurality of cold-cathode tubes used in a back light device of a liquid crystal display and so on, it is possible to detect a current of each load synchronously with selective drive of the plurality of loads by means of the time division. Because of this, there is no need to provide individually the composition for a current detection at every load, and it is possible to realize detecting accuracy equivalent to the case of an individual current detection. Along with this, it is possible to simplify the composition for a current detection or to make this composition singleness.

(3) Along with the simplification of the composition for the current detection, it is possible to simplify wiring of a load side of every load required for a current detection of a plurality of loads or to make this wiring singleness. For example, it is possible to simplify wiring of a cold side in cold-cathode tubes or to make this wiring singleness. By this, since a space factor for the wiring is reduced, the miniaturization of a device and the reduction of a production cost are given.

### BRIEF DESCRIPTION OF THE DRAWINGS

The foregoing and other objects, features and attendant advantages of the present invention will be appreciated as the same become better understood by means of the following description and accompanying drawings wherein:

FIG. 1 is a circuit diagram showing a composition of a prior back light device;

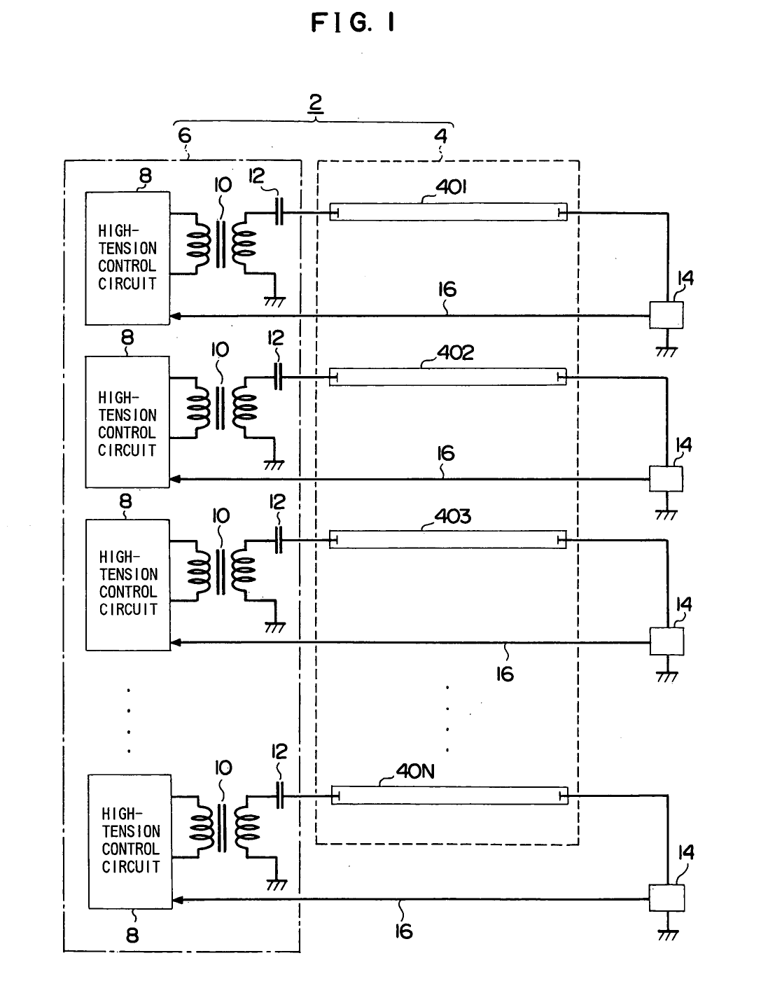

FIG. 2 is a circuit diagram showing a composition of another prior back light device;

FIG. 3 is a circuit diagram showing a composition of a back light device according to a first embodiment of the present invention;

FIG. 4 is a circuit diagram showing a composition of a back light device according to a second embodiment of the present invention;

FIG. 5 is a timing chart showing operation of the back light device according to the second embodiment of the present invention;

FIG. 6 is a circuit diagram showing a composition of a back light device according to a third embodiment of the present invention;

FIG. 7 is a timing chart showing operation of the back light device according to the third embodiment of the present invention;

FIG. 8 is a flow diagram showing the operation of the back light device according to the third embodiment of the present invention; and

FIG. 9 is a perspective view showing a personal computer according to a fourth embodiment of the present invention.

### DETAILED DESCRIPTION OF THE PREFERRED EMBODIMENTS

### First Embodiment

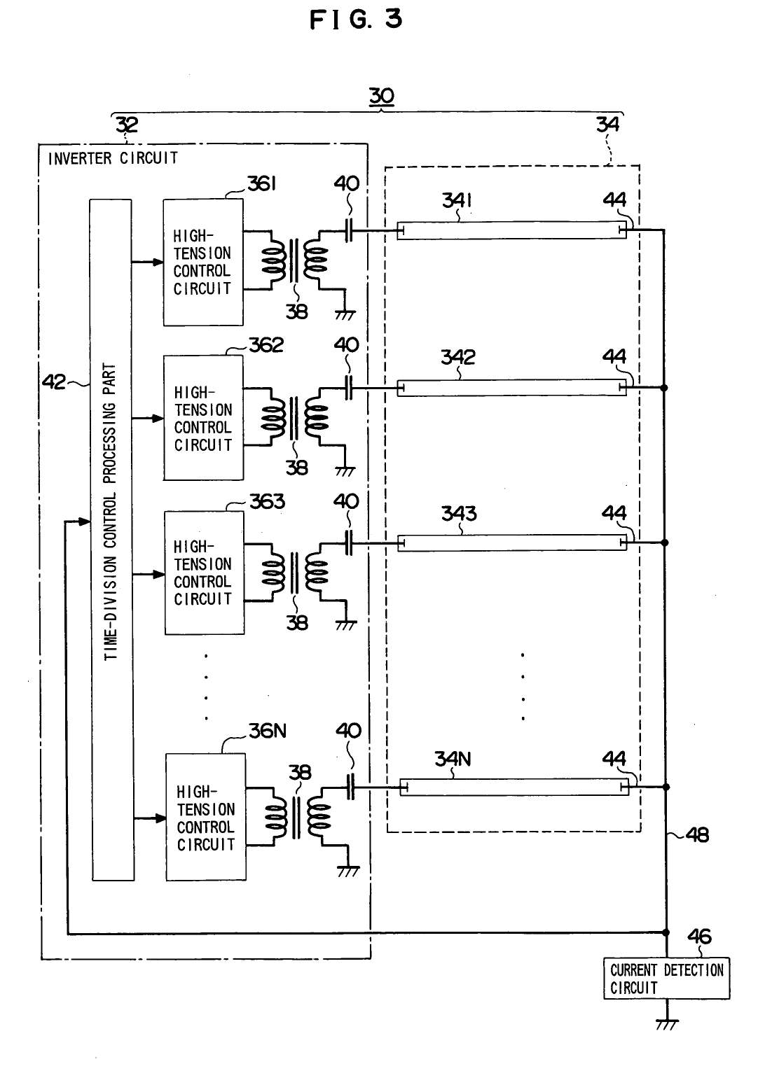

A first embodiment of the present invention is explained by referring to FIG. 3. FIG. 3 shows an outline of a back light device according to the first embodiment of the present invention.

This back light device 30 is constituted as a back-side light source of a transmissive display device of a liquid crystal display and so on not shown in the drawing. The back light device 30 has an inverter circuit 32 serving as a driving device of various kinds of loads, also has a cold-cathode tube group 34 as an example of a plurality of loads, and forms a cold-cathode tube inverter. The cold-cathode tube group 34 is constituted by cold-cathode tubes 341, 342, 343, . . . and 34N. In this case, the inverter circuit 32 is a power supply unit toward each load of the cold-cathode tubes 341, 342, 343, . . . and 34N and so on. This inverter circuit 32 corresponds to the cold-cathode tubes 341, 342. 343, . . . and 34N, provides high-tension control circuits 361, 362, 363, . . . and 36N, boosting transformers 38, capacitors 40 and so on as a driving part of those, and also provides a time-division control processing part 42 which controls selectively the operation of each of the high-tension control circuits 361, 362, 363, . . . and 36N. Each of the high-tension control circuits 361, 362, 363, . . . and 36N converts an direct-current input into for example a high-frequency alternating current, and gives to a corresponding boosting transformer 38 in order to make it a high-voltage. In this embodiment, the cold-cathode tubes 341, 342, 343, . . . and 34N are constituted as a lighting unit.

According to a composition like this, each of the high-tension control circuits 361, 362, 363, . . . and 36N is operated every predetermined time by the time-division control processing part 42. Then, a driving voltage which is generated in sequence at every predetermined time from the high-tension control circuits 361, 362, 363, . . . and 36N is given to each of the cold-cathode tubes 341, 342, 343, . . . 34N through the corresponding boosting transformer 38 and the corresponding capacitor 40, and each of the cold-cathode tubes 341, 342, 343, . . . and 34N is driven in sequence at every predetermined time. If each lighting time of the cold-cathode tubes 341, 342, 343, . . . and 34N is set to a short time, this can be regarded as a state that each of the cold-cathode tubes 341, 342, 343, . . . and 34N is lighted up at the same time by afterimage of eyes.

Further, one electrode of each of the cold-cathode tubes 341, 342, 343, . . . and 34N, namely each of cold-side electrodes 44 in this embodiment, is connected in common, and a current detection part 46 is connected to each of the cold-side electrodes 44 which are made in common by the connection. This current detection part 46 constitutes an abnormality detection part which detects abnormality of a current level. In this case, concerning the plurality of cold-cathode tubes 341, 342, 343, . . . and 34N, the only current detection part 46 is arranged. This current detection part 46 detects individually a current of each of the cold-cathode tubes 341, 342, 343, . . . and 34N through each cold-side electrode 44, and gives that detection information as feedback to the time-division control processing part 42 through a feedback circuit 48. The current detection part 46, for example, converts a current into a voltage level to take out it, and impresses this voltage level as control information to the time-division control processing part 42. That is, the current detection part 46 detects abnormality of a current, and this detected output is taken into the time-division control processing part 42 as the control information representative of the abnormality. In this case, the time-division control processing part 42 controls to a state that the high-tension control circuits 361, 362, 363, . . . and 36N are selectively operated at predetermined time intervals, and thereby, makes each of the cold-cathode tubes 341, 342, 343, . . . and 34N light up in sequence at every predetermined time. Along with this, the time-division control processing part 42 takes in a current from the current detection part 46 synchronously with the cold-cathode tube 341, 342, 343, . . . or 34N which is being lighted. That is, lighting timing as the drive timing of the cold-cathode tube 341, 342, 343, . . . or 34N and detection timing of a current are synchronized by means of the time division, and a current of the cold-cathode tube 341, 342, 343, . . . or 34N which is being lighted is detected and supervised at each of the cold-cathode tube 341, 342, 343, . . . and 34N.

According to a composition like this, by lighting sequence of the time-division control processing part 42, a driving voltage is output every predetermined time in sequence from the high-tension control circuits 361, 362, 363, . . . 36N, respectively, and the cold-cathode tubes 341, 342. 343, . . . and 34N to which each of the driving voltages is given through the corresponding boosting transformer 38 and the corresponding capacitor 40 are to be lighted up in sequence. Each current flowing through the cold-cathode tubes 341, 342, 343, . . . and 34N during lighting flows through the feedback circuit 48 provided in common and is detected by the current detection part 46. Then, for example, after converting into a voltage level, it is provided as feed back to the time-division control processing part 42 and is supervised.

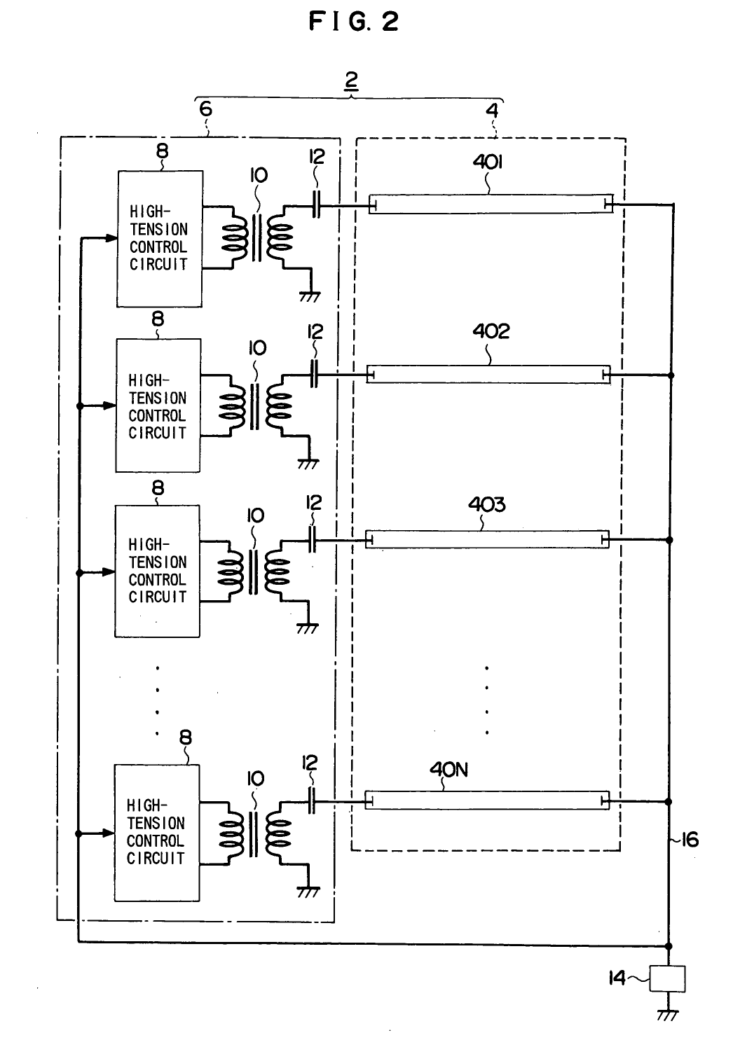

As described above, since an individual current of the cold-cathode tubes 341, 342, 343, . . . and 34N is supervised according to sequential lighting of the cold-cathode tubes 341, 342, 343, . . . and 34N by means of the time division, a current detected by the current detection part 46 is the individual current of each of the cold-cathode tubes 341, 342, 343, . . . and 34N. That is, since a variation quantity of a current in each of the cold-cathode tubes 341, 342, 343, . . . and 34N can be detected with high accuracy without being added as shown in the prior current detection of FIG. 2, the decision of normality or abnormality becomes easy, and the accuracy of a decision can be improved. An erroneous detection in the prior art caused by a very small variation quantity can be prevented, and it is enough if the single current detection part 46 is provided in respect to the plurality of cold-cathode tubes 341, 342, 343, . . . and 34N. Further, since the feedback circuit 48 can also be simplified, the simplification of a circuit composition can be given. In this case, in an impedance equipment and so on of impulse drive and so on which are always driven by time division, since supervision of a current and feedback always become possible in an ordinary condition, this composition becomes effective means in particular. That is, abnormality is detected synchronously with the drive timing of the loads. Although in this embodiment normality or abnormality is detected from the level of a current, the normality or the abnormality may also be detected from the level of a voltage.

In this embodiment, the ordinary lighting operation and the current detection of the cold-cathode tubes 341, 342, 343, . . . and 34N are performed simultaneously, that is, the current detection is executed synchronously with the lighting sequence by means of the time division. Upon this, as for another embodiment, the ordinary lighting and the current detection may also be performed by different sequence, respectively. In this case, static lighting which makes each of the cold-cathode tubes 341, 342, 343, . . . and 34N light up at the same time is performed as ordinary lighting operation, and switching to the sequence of a fault detection (a current detection) different from the lighting sequence is performed. Then, in this sequence, the current detection described in the above embodiment may also be performed.

As described above, even if either of this embodiment and another embodiment is used, for example, in a back light system in which the plurality of cold-cathode tubes 341, 342, 343, . . . and 34N are directly arranged in a rear face of a transmissive display device such as a liquid crystal display, an individual detection equivalent to the case in which the current detection part 46 is individually provided to each of the cold-cathode tubes 341, 342, 343, . . . and 34N is realized by time-division-driving the high-tension control circuits 361, 362, 363, . . . and 36N of the inverter circuit 32, which are the individual driving parts, in order to detect an individual fault of the cold-cathode tubes 341, 342, 343, . . . and 34N. By this, it is possible to perform impedance measurement of an optional cold-cathode tube out of the cold-cathode tubes 341, 342, 343, . . . and 34N by means of the only current detection part 46.

### Second Embodiment

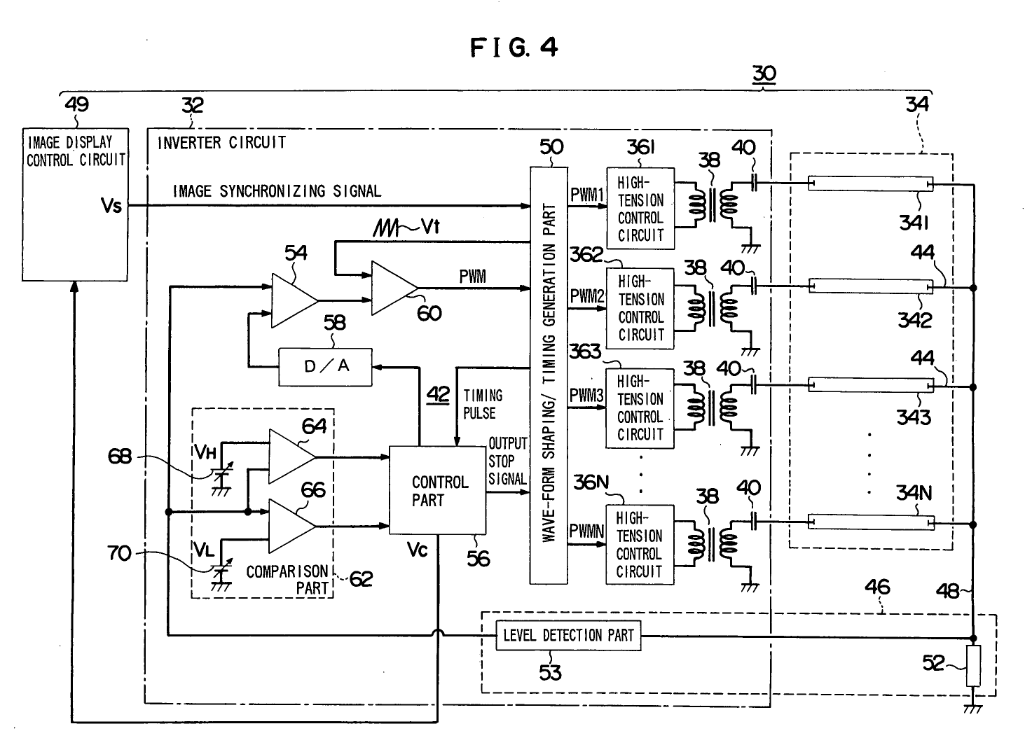

A second embodiment of the present invention is explained by referring to FIG. 4. FIG. 4 shows an outline of a back light device according to the second embodiment of the present invention.

In a back light device 30 of this second embodiment, the composition and operation of an inverter circuit 32 serving as a driving device, cold-cathode tubes 341, 342, 343, . . . and 34N as a plurality of loads thereof, and high-tension circuits 361, 362, 363, . . . and 36N, boosting transformers 38 and capacitors 40 serving as a driving part thereof are as described in the first embodiment. Therefore, explanation of those functions is omitted.

An image display control part 49, for example, is provided to an image system of a television receiver, a display unit, a personal computer (PC) and so on, and performs the control of an image display of a liquid crystal display not shown in the drawing. Further, in a time-division control processing part 42 of the inverter circuit 32, a wave-form shaping/timing generation part 50 is provided. This wave-form shaping/timing generation part 50 receives an image synchronizing signal Vs from the image display control part 49 described above. Then, by using it as a synchronizing signal, the wave-form shaping/timing generation part 50 generates lighting timing (drive timing), a detection timing pulse, a saw-tooth voltage Vt by wave-form shaping, and control output signals PWM1, PWM2, PWM3, . . . and PWMN corresponding to each of the high-tension control circuits 361, 362, 363, . . . and 36N. Further, the wave-form shaping/timing generation part 50 receives an output stop signal and performs a stop of operation, and so on.

In a current detection part 46 serving as an abnormality detection part which detects abnormality of a load, a current detecting element 52 composed of a resistor and so on is provided, and a level detection part 53 is also provided. In this embodiment, the current detecting element 52 is connected between the cold-side electrode 44 of each of the cold-cathode tubes 341, 342, 343, . . . and 34N and a ground point. A current of each of the cold-cathode tubes 341, 342, 343, . . . and 34N is converted into a voltage to be taken out in the current detecting element 52, and this voltage is taken out as level information representative of a current variation by way of a process of rectification, smoothing and so on by the level detection part 53. This voltage is a detected voltage. This detected voltage is used for brightness control and an abnormality detection of the cold-cathode tubes 341, 342, 343, . . . and 34N. The current detecting element 52 may also be constituted by an active element of a transistor and so on.

Therefore, in order to obtain information necessary for the brightness control from the detected voltage, the inverter circuit 32 has an error amplifier 54. To this error amplifier 54, the detected voltage is given, and a variable brightness voltage which is variable brightness information issued from a control part 56 is converted into an analog value through a digital-to-analog converter (D/A) 58 and is also given. The control part 56, for example, is constituted by a microcomputer. The control part 56 sets the driving timing and the detection timing, and also constitutes a decision part which decides whether or not a level of a detected value, for example, a level of a detected current, is normal. Since the detected voltage represents brightness of the cold-cathode tubes 341, 342, 343, . . . and 34N, an error voltage which is a difference between the detected voltage and the variable brightness voltage namely a reference value thereof is obtained by the error amplifier 54. This error voltage is compared with the saw-tooth voltage Vt by a comparator 60, a pulse-width modulation output signal PWM which has a pulse width according to a value of the error voltage is obtained, and it is given to the wave-form shaping/timing generation part 50. That is, in the error amplifier 54 and the comparator 60, duty control which is the control of a pulse width according to the error voltage is executed toward a pulse width corresponding to the reference brightness. Then, the control output signals PWM1, PWM2, PWM3, . . . and PWMN corresponding to each of the high-tension control circuits 361, 362, 363, . . . and 36N are output as the pulse-width modulation output signal PWM synchronously with the detection timing which is generated from the image synchronizing signal Vs, and the cold-cathode tubes 341, 342, 343, . . . and 34N are to be lighted up in sequence by these control output signals PWM1, PWM2, PWM3, . . . and PWMN.

Further, in the inverter circuit 32, a comparison part 62 is provided as a window comparator which detects whether or not the detected voltage of the current detection part 46 is within the range of a normal value. This comparison part 62 has first and second comparators 64 and 66, and the detected voltage is given to each of the comparators 64 and 66. Along with this, an upper reference voltage VH (a decision reference value of abnormality/normality) is set from a reference voltage source 68 for the comparator 64, and a lower reference voltage VL (a decision reference value of abnormality/normality) is set from a reference voltage source 70 for the comparator 66. Upon this, in case in which the detected voltage is more than the lower reference voltage VL and is less than the upper reference voltage VH, output representative of the normality is obtained from the comparators 64 and 66. If the detected voltage exceeds the upper reference voltage VH, output representative of the abnormality is obtained from the comparator 64, and, if the detected voltage is lower than the lower reference voltage VL, output representative of the abnormality is obtained from the comparator 66. The reference voltage sources 68 and 70 are constituted by a variable voltage source, respectively, and the upper reference voltage VH and the lower reference voltage VL are optionally set according to an upper limit level and a lower limit level which are the normal range of the detected voltage representative of a current flowing through each of the cold-cathode tubes 341, 342, 343, . . . and 34N. Since each of the reference voltages VH and VL are set to a level able to detect whether or not abnormality is occurring in each of the cold-cathode tubes 341, 342, 343, . . . and 34N, in case in which the detected voltage is within “the range above the lower reference voltage VL and below the upper reference voltage VH, ±ΔV”, the comparison output representative of normality is obtained from the comparison part 62, and, in case in which the detected voltage is not within “the range above the lower reference voltage VL and below the upper reference voltage VH, ±ΔV”, the comparison output representative of abnormality is obtained from the comparison part 62.

Further, the control part 56 receives the detection timing pulse from the wave-form shaping/timing generation part 50, and takes in a comparison result of the detected voltage from the comparison part 62 synchronously with order of lighting of the cold-cathode tubes 341, 342, 343, . . . and 34N. Then, in case in which the comparison result of the comparison part 62 represents abnormality, the control part 56 generates the output stop signal, and makes the operation of the wave-form shaping/timing generation part 50 stop. On the other hand, in case in which the comparison result of the comparison part 62 represents normality, the operation of the wave-form shaping/timing generation part 50 is to be made to keep. In this case, the control part 56 may also be constituted so as to receive the comparison result of the comparison part 62, to perform an issue of a fault diagnosis code representing which cold-cathode tube 341, 342, 343, . . . or 34N is abnormal, and so on, to generate a status Vc representative of abnormality or normality of upkeep/stop of the display of a liquid crystal display, and soon, and to give them to the image display control part 49 and so on.

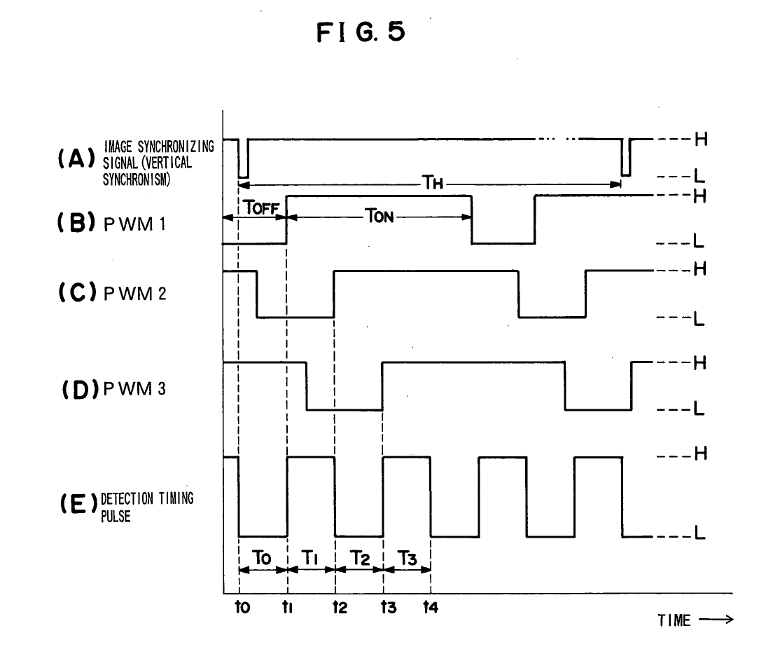

Operation of this back light device 30 is explained by referring to a timing chart shown in FIG. 5. In FIG. 5, a lateral axis shows a time “t”, and, at each pulse, “L” shows a low level section and “H” shows a high level section.

To the wave-form shaping/timing generation part 50, the image synchronizing signal shown in FIG. 5(A) is given, and the detection timing pulse shown in FIG. 5(E) is generated by this image synchronizing signal. In this embodiment, a vertical synchronizing signal is used as the image synchronizing signal. The detection timing pulse at its falling edge or rising edge is synchronized with a falling edge of the vertical synchronizing signal, and the detection timing pulse has 2.5 periods per one period TH of the vertical synchronizing signal and is formed by a duty ratio 50%. Further, as shown in FIG. 5(B), (C) and (D), the signals PWM1, PWM2 and PWM3 which rise correspondingly to the rising edge or falling edge of the detection timing pulse are generated. Although showing in the drawing is not performed, the signals PWM4, . . . and PWMN are generated similarly.

At this, the detection timing pulse falls synchronously with falling of the image synchronizing signal at a time point t₀. After the lapse of a time T₀ from the time point t₀ set by the detection timing pulse to a time point t₁, as shown in FIG. 5(B), the signal PWM1 rises, and falls after the lapse of a predetermined lighting time TON. The cold-cathode tube 341 is turned ON at this lighting time TON, and is turned OFF at a non-lighting time TOFF. Further, after the lapse of a time T₁ from the time point t₁ of the detection timing pulse to a time point t₂, as shown in FIG. 5(C), the signal PWM2 rises. By this, similarly, the cold-cathode tube 342 is turned ON at a high level section of the signal PWM2, and is turned OFF at its low level section. Furthermore, after the lapse of a time T₂ from the time point t₂ of the detection timing pulse to a time point t₃, as shown in FIG. 5(D), the signal PWM3 rises. By this, similarly, the cold-cathode tube 343 is turned ON at a high level section of the signal PWM3, and is turned OFF at its low level section. Operation like this is repeated in sequence like a chain, and the cold-cathode tubes 341, 342, 343, . . . and 34N are to be lighted up. For example, assuming that one scanning period of the image synchronizing signal is set to, for example, a time about 16.5 milliseconds by a signal of 60 Hz, the cold-cathode tubes 341, 342, 343, . . . and 34N are lighted up in sequence by waiting the lapse of the time 16.5 milliseconds.

The individual lighting time TON of each of the cold-cathode tubes 341, 342, 343, . . . and 34N is controlled by the detected voltage which is detected by the current detecting element 52, and thereby, the brightness control of the cold-cathode tubes 341, 342, 343, . . . and 34N is performed as described before. That is, by length of the lighting time TON, an overlapping lighting time of the cold-cathode tube 341, 342, 343, . . . or 34N is adjusted, and the brightness is modified.

Further, as shown in FIG. 5(E), the time T₁ of the detection timing pulse is set to a current detection period of the cold-cathode tube 341, the time T₂ is set to a current detection period of the cold-cathode tube 342, and the time T₃ is set to a current detection period of the cold-cathode tube 343. In each of the times T₁, T₂, T₃, . . . , a current of a cold-cathode tube, which is lighted up, out of the cold-cathode tube 341, 342, 343, . . . and 34N, is detected. Then, whether or not abnormality exists in a corresponding cold-cathode tube out of the cold-cathode tube 341, 342, 343, . . . and 34N is detected and decided from that current value. On the basis of a result of this decision, in case in which abnormality is occurring at any of the cold-cathode tube 341, 342, 343, . . . and 34N, the output stop signal is given to the wave-form shaping/timing generation part 50 from the control part 56, and a stop of lighting is performed. In this case, the fault diagnosis code and the status Vc representative of a fault toward a liquid crystal display are output, are given to the image display control part 49, and are displayed on a display part of a transmissive display device.

According to a composition like this, in case in which abnormality occurs at any of the cold-cathode tubes 341, 342, 343, . . . and 34N, the occurrence of unforeseen discharge from a high-tension electrode due to continuation of supply of a driving voltage can be prevented, and an unforeseen situation caused by occurrence of discharge like this can also be prevented. Occurrence of heat in an element and occurrence of a short-circuit caused by an abnormal current flowing through the inverter circuit 32 can be prevented previously, and an accident of fuming, firing and so on due to an overcurrent can also be prevented previously.

### Third Embodiment

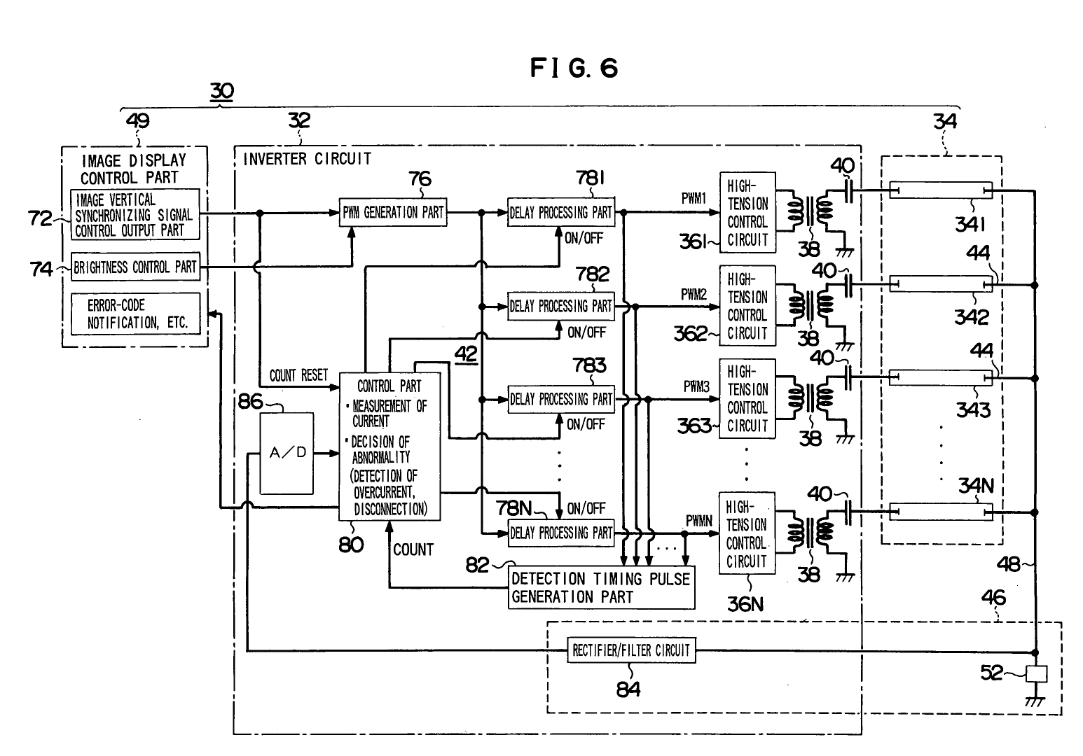

A third embodiment of the present invention is explained by referring to FIG. 6. FIG. 6 shows an outline of a back light device according to the third embodiment of the present invention.

In a back light device 30 of this third embodiment, the composition and operation of an inverter circuit 32 serving as a driving device, cold-cathode tubes 341, 342, 343, . . . and 34N as a plurality of loads thereof, and high-tension circuits 361, 362, 363, . . . and 36N, boosting transformers 38 and capacitors 40 serving as a driving part thereof are as described in the first embodiment. Therefore, explanation of those functions is omitted.

An image display control part 49, for example, is provided to an image system of a television receiver, a display unit, a personal computer (PC) and so on, and has an image vertical synchronizing signal output part 72, a brightness control part 74 and so on. The image vertical synchronizing signal output part 72 outputs a vertical synchronizing signal, and the brightness control part 74 outputs a brightness control signal.

In the inverter circuit 32, a PWM generation part 76 serving as a driving output generation part which generates a PWM output signal as a driving output to the high-tension control circuits 361, 362, 363, . . . and 36N is provided. This PWM generation part 76 generates the PWM output signal synchronizing with the image vertical synchronizing signal by receiving the image vertical synchronizing signal, and a pulse width of the PWM output signal is controlled by the brightness control signal from the brightness control part 74. Further, a plurality of delay processing parts 781, 782, 783, . . . and 78N are provided so as to correspond to the cold-cathode tubes 341, 342, 343, . . . and 34N in order to light up in sequence by delaying individually a start of lighting of each of the cold-cathode tubes 341, 342, 343, . . . and 34N by a predetermined time interval. The delay processing parts 781, 782, 783, . . . and 78N, responsive to switching signals for making a delay action occur at the predetermined time interval from a control part 80, generate control output signals PWM1, PWM2, PWM3, and PWMN corresponding to the cold-cathode tubes 341, 342, 343, . . . and 34N from the single PWM output signal. In this case, distribution of the PWM output signal to each of the delay processing parts 781, 782, 783, . . . and 78N is constituted by a wired-or connection. It is enough if each of the delay processing parts 781, 782, 783, . . . and 78N is a circuit which conducts at the predetermined time interval in response to the switching signal and generates the control output signal PWM1, PWM2, PWM3, . . . or PWMN delayed by a predetermined time from the single PWM output signal, and these are not limited to a specific composition. For example, each of the delay processing parts 781, 782, 783, . . . and 78N can be constituted by a D-FF (D Flip-Flop), a gate circuit and so on.

Further, a detection timing pulse generation part 82 receives the control output signals PWM1, PWM2, PWM3, . . . and PWMN from the delay processing parts 781, 782, 783, . . . and 78N, and generates a detection timing pulse representative of the detection timing of a current corresponding to lighting timing (drive timing) of the cold-cathode tubes 341, 342, 343, . . . and 34N by completion of the condition of AND operation, and so on. The generated detection timing pulse is used as distinction information of the cold-cathode tubes 341, 342, 343, . . . and 34N in the control part 80.

The control part 80 corresponds to the control part 56 in the second embodiment, and is constituted by a microcomputer and so on. The control part 80 constitutes a decision part which performs the measurement of a current, performs the detection of an overcurrent and the detection of disconnection as a decision of abnormality, and decides abnormality or normality. Further, the control part 80 provides internally a counter for executing measurement of duration of abnormality and a count of the number of times of abnormality. This control part 80 receives the vertical synchronizing signal. And, by using the vertical synchronizing signal for count reset of the detection timing pulse, the control part 80 counts the detection timing pulse by using the vertical synchronizing signal as a starting point. Then, the control part 80 makes the plurality of the cold-cathode tubes 341, 342, 343, . . . and 34N light up in sequence at one vertical synchronizing period TH, and takes in current detection information at a lighting period of the cold-cathode tubes 341, 342, 343, . . . or 34N which is lighted up.

Accordingly, in this embodiment, by a current flowing through each of the cold-cathode tubes 341, 342, 343, . . . and 34N which are loads, a detected voltage which is generated in a current detecting element 52 of a current detection part 46 serving as an abnormality detection part detecting abnormality of a load is converted into a direct-current level signal by a rectifier/filter circuit 84 serving as a level detection part, and, after that, the detected voltage is converted into a digital signal by an analog-to-digital conversion part (A/D) 86 and is given to the control part 80. Therefore, in the control part 80, as described before, the decision of abnormality of overcurrent, disconnection or the like is performed from a detected voltage level corresponding to each of the cold-cathode tubes 341, 342, 343, . . . and 34N as the measurement of a current. Then, an error-code notification issued from the control part 80 is given to the image display control part 49, and is displayed as an error code. The display of this code may also be performed by a voice.

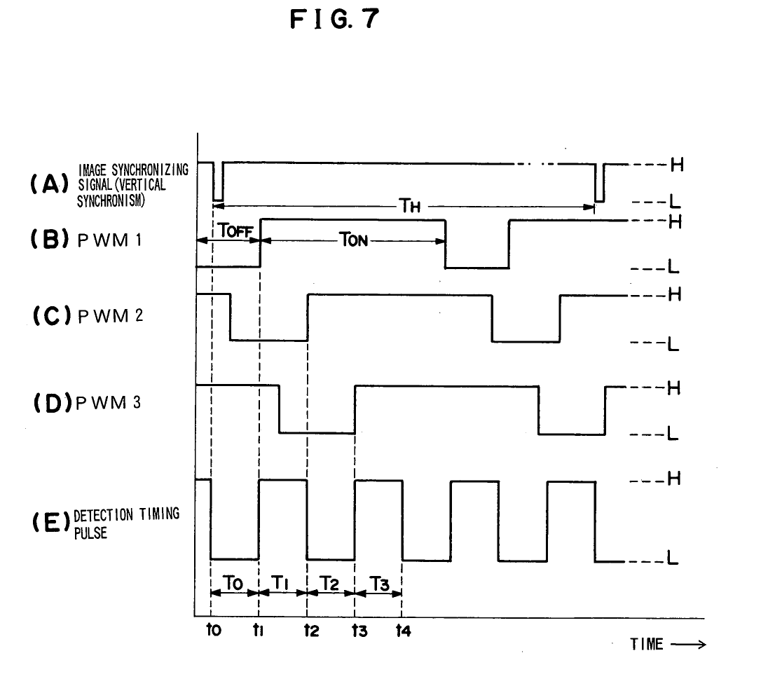

In connection with the lighting and the current detection of each of the cold-cathode tubes 341, 342, 343, . . . and 34N like this, for example, the detection timing pulse is generated correspondingly to the vertical synchronizing signal as shown in FIG. 7(A) and (E), and, in the delay processing parts 781, 782, 783, . . . and 78N, for example, the control output signals PWM1, PWM2 and PWM3 are obtained as shown in FIG. 7(B), (C) and (D). Although showing in the drawing is not performed, the control output signals PWM4, . . . and PWMN are generated by the same processing. In each of the control output signals PWM1, PWM2 and PWM3, a lighting time TON and a non-lighting time TOFF are set alternately. In FIG. 7(E), T₀ is a delay time which is set by a half period of the detection timing pulse, a time T₁ is a current detection period of the cold-cathode tube 341, a time T₂ is a current detection period of the cold-cathode tube 342, and a time T₃ is a current detection period of the cold-cathode tube 343.

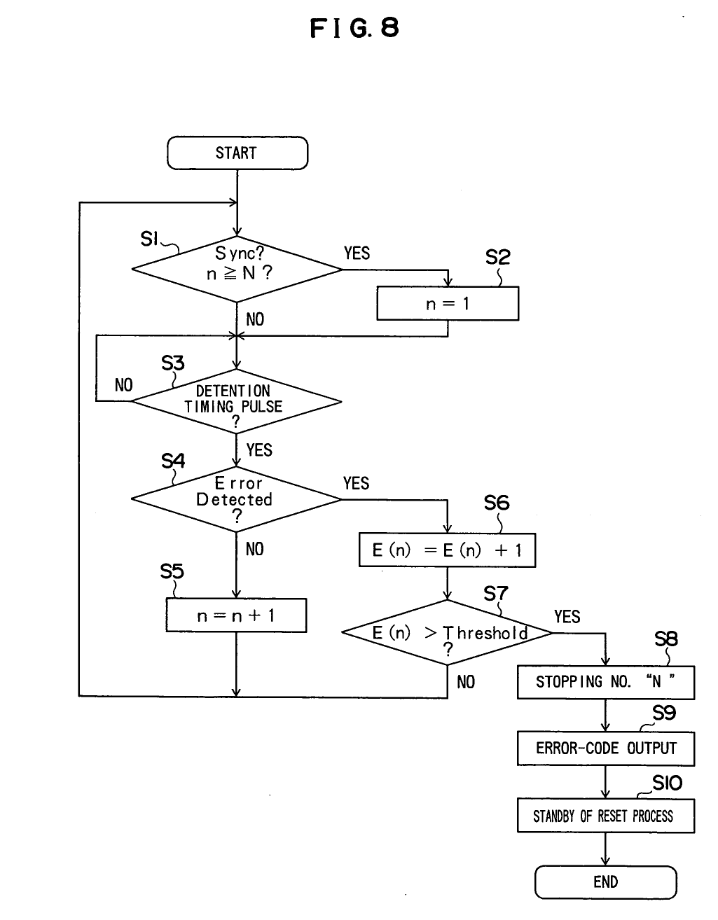

Next, the current detection and the error-code output processing by the control part 80 and so on are explained by referring to FIG. 8. FIG. 8 shows the contents of processing in the control part 80.

In this processing, at a step S1, whether or not the vertical synchronizing signal exists is decided, and whether a count value “n” of the counter is the number “N” of the cold-cathode tubes 341, 342, 343, . . . and 34N or a number more than that is decided. At the coming of the first vertical synchronizing signal (Sync), the count reset (n=1) is performed (a step S2). On the other hand, in case in which it is not the first vertical synchronizing signal, whether or not the detection timing pulse comes is decided (a step S3). Then, in accordance with the coming of this detection timing pulse, a current detection is executed and the decision of an error is performed (a step S4). The current detection is performed by converting into the detected voltage described before, and whether or not an error occurs is decided by the abnormality of its level.

As a result of this error decision, in case in which abnormality does not exist, the count value “n” of the counter is increased (n=n+1) (a step S5), and the processing is returned to the step S1.

On the other hand, as a result of the error decision, in case of a decision that abnormality exists, an error cumulated value E(n) which is accumulated in the counter is increased {E(n)=E(n)+1} (a step S6). Then, whether or not this cumulated value E(n) exceeds an error reference value (Threshold) which is a predetermined value is decided (a step S7). When that cumulated value E(n) does not exceed the error reference value (Threshold), the processing is returned to the step S1. On the other hand, when that cumulated value E(n) exceeds the error reference value (Threshold), operation of a cold-cathode tube No. “n”, in which abnormality is occurring, out of the cold-cathode tubes 341, 342, 343, . . . and 34N, is stopped (a step S8). After that, error-code output is issued (a step S9), and the standby of a reset process is given (a step S10).

According to a composition like this, a current of each of the cold-cathode tubes 341, 342, 343, . . . and 34N is detected at a lighting period synchronously with the sequential lighting by means of the time division of the cold-cathode tubes 341, 342, 343, . . . and 34N which are a plurality of loads, and abnormality of its level is decided. When the abnormality of the level occurs by the predetermined number of times, the decision that a fault exists is given, and the drive of the cold-cathode tubes 341, 342, 343, . . . and 34N is stopped. In this case, since the lighting timing and the detection timing are synchronized, it is possible to specify a cold-cathode tube having the abnormality from the cold-cathode tubes 341, 342, 343, . . . and 34N, and to normalize it by exchange and so on.

In this embodiment, stop control of each of the high-tension control circuits 361, 362, 363, . . . and 36N, for example, is executed by control (Output Disable) which makes the delay processing parts 781, 782, 783, . . . and 78N provided at a forward stage thereof an OFF state and makes output thereof stop.

Further, in this embodiment, the microcomputer which constitutes the control part 80 supervises an error while obtaining an ID, which is the distinction information of the cold-cathode tubes 341, 342, 343, . . . and 34N namely controlled objects, with the vertical synchronizing signal as a momentum. In this case, the error frequency E (n) of a cold-cathode tube No. “n” out of the cold-cathode tubes 341, 342, 343, . . . and 34N is recorded, and, if the error cumulated value exceeds a certain amount, a corresponding driving part, namely a corresponding high-tension control part out of the high-tension control parts 361, 362, 363, . . . and 36N, is made to stop. Then, the error code is output and is given to the image display control part 49. By processing like this, a processing error due to a decision based on an one-shot error is prevented, and reliability in the detection of abnormality is heightened.

Furthermore, in this embodiment, the brightness control of the cold-cathode tubes 341, 342, 343, . . . and 34N is executed by the brightness control output of the brightness control part 74 in the image display control part 49, and is similarly performed by the duty control of the PWM output for forming the control output signals PWM1, PWM2, PWM3, . . . and PWMN.

### Fourth Embodiment

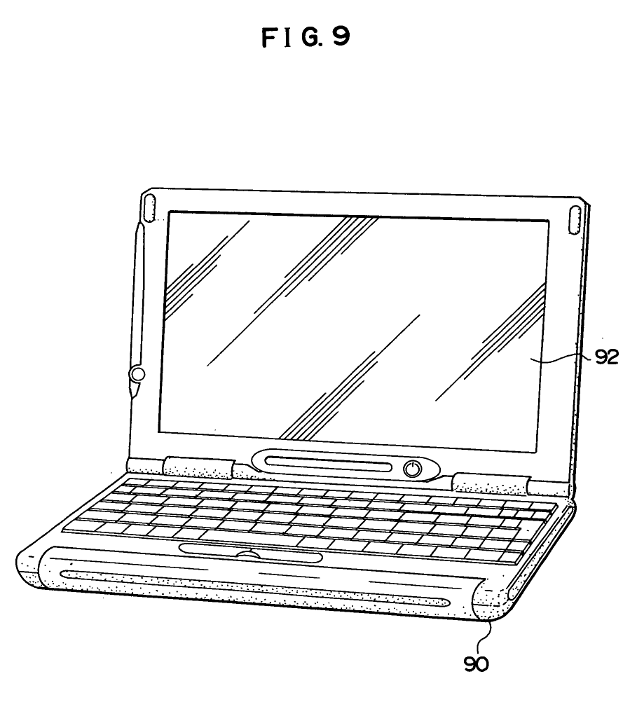

A fourth embodiment of the present invention is explained by referring to FIG. 9. FIG. 9 shows an outline of a personal computer according to the fourth embodiment of the present invention.

In this personal computer 90, a transmissive display device is used for a display part 92, and, at its rear face, the back light device 30 according to the first, second or third embodiment described before is internally provided as back light sources.

By giving a composition like this, the time-division drive of the light sources by the back light device 30 is performed, and a current of each light source is monitored synchronously with its driving timing. By this, it is possible to always supervise abnormality of each light source. Further, it is not necessary to set a particular drive period for supervising the light sources, and the supervision of abnormality can be performed in ordinary lighting operation. Furthermore, since continuous operation of a light source which is in an abnormal condition is not performed, for example, if application to an information processing device is performed, its safety can be heightened and operation with high reliability can be realized.

In connection with the embodiments described above, modified examples of those are enumerated in the following.

(1) Although in each embodiment the cold-cathode tubes 341, 342, 343, . . . and 34N are illustrated as the plurality of loads, the driving device and method according to the present invention are not limited to the cold-cathode tubes as objects of abnormality detection. The present invention can be widely applied to the detection of abnormality in case of not only the drive of light sources of a cold-cathode tube inverter, an actuator and so on, which makes the plurality of cold-cathode tubes light up, but also the drive of other loads.

(2) Although in each embodiment a current level of each cold-cathode tube 341, 342, 343, . . . or 34N is exemplified as the detection of abnormality, a voltage level of electrodes of each cold-cathode tube 341, 342, 343, . . . or 34N may also be supervised. Further, as a form of abnormality, the present invention can be applied to not only the abnormality of a load such as a cold-cathode tube but also the supervision of abnormality of a driving part side of a load circuit, the high-tension control circuits 361, 362, 363, . . . and 36N, the boosting transformers 38, the capacitors 40 and so on.

(3) Although in the embodiments the single control part 56 or 80 is exemplified as a unit which performs the current measurement and the decision of abnormality, the decision of a level of a current level and so on and the decision of whether or not a fault occurs may also be constituted by an independent decision part, respectively. The present invention is not limited to the single control part 56 or 80 which is constituted by a microcomputer and so on.

Although the best mode for carrying out the invention, the object, the configuration and the operation and effect have been described in detail above, the invention is not limited to such embodiment for carrying out the invention, and it is a matter of course that the invention can be variously changed or modified by a person skilled in the art on the basis of a gist and split of the invention as disclosed in claims and the detailed description of the invention, and such a change or modification, and various conjectured configurations, modified examples and so forth are included in the scope of the invention, and the description of the specification and drawings are not restrictively understood.

The entire disclosure of Japanese Patent Application No. 2004-004423 including specification, claims, drawings and summary are incorporated herein by reference in its entirety.

1. A driving device which drives a plurality of loads in sequence, comprising:
a driving part that drives each of said loads in sequence by means of time division; and
an abnormality detection part that detects abnormality of each of said loads at the time of drive of each of said loads.

2. The driving device of claim 1, wherein said abnormality detection part detects a current flowing through each of said loads.

3. The driving device of claim 2, wherein said abnormality detection part decides whether a level of said current which is detected is normal or abnormal.

4. The driving device of claim 1, wherein said abnormality detection part decides on badness of behavior in case in which said abnormality is detected continuously by the predetermined number of times at detection timing or for a predetermined time.

5. The driving device of claim 3, wherein said abnormality detection part decides on badness of behavior in case in which said abnormality is detected continuously by the predetermined number of times at detection timing or for a predetermined time.

6. The driving device of claim 1, wherein said load is a cold-cathode tube inverter which makes a cold-cathode tube light up.

7. The driving device of claim 2, wherein said load is a cold-cathode tube inverter which makes a cold-cathode tube light up.

8. The driving device of claim 3, wherein said load is a cold-cathode tube inverter which makes a cold-cathode tube light up.

9. The driving device of claim 4, wherein said load is a cold-cathode tube inverter which makes a cold-cathode tube light up.

10. The driving device of claim 1, wherein:
said driving part controls sequential drive of each of said loads by drive timing, and delays by a predetermined time to drive each of said loads in sequence by means of the drive timing which is generated; and
said abnormality detection part detects abnormality of each of said loads so as to match with the sequential drive delayed by the predetermined time.

11. The driving device of claim 2, wherein said abnormality detection part detects a current of said loads by converting into a voltage.

12. The driving device of claim 3, wherein said abnormality detection part detects a current of said loads by converting into a voltage.

13. The driving device of claim 1, wherein:
said driving device can also drive said plurality of loads at the same time; and
said abnormality detection part detects abnormality of each of said loads in case in which said loads are driven in sequence.

14. A driving method which drives a plurality of loads in sequence, comprising:
a process that drives each of said loads in sequence by means of time division; and
a process that detects abnormality of each of said loads at the time of drive of each of said loads.

15. The driving method of claim 14, wherein said process that detects abnormality of each of said loads detects a current flowing through each of said loads.

16. The driving method of claim 15, wherein said process that detects abnormality of each of said loads decides whether a level of said current which is detected is normal or abnormal.

17. The driving method of claim 14, wherein said process that detects abnormality of each of said loads decides on badness of behavior in case in which said abnormality is detected continuously by the predetermined number of times at detection timing or for a predetermined time.

18. The driving method of claim 16, wherein said process that detects abnormality of each of said loads decides on badness of behavior in case in which said abnormality is detected continuously by the predetermined number of times at detection timing or for a predetermined time.

19. The driving method of claim 14, wherein said load is a cold-cathode tube inverter which makes a cold-cathode tube light up.

20. The driving method of claim 15, wherein said load is a cold-cathode tube inverter which makes a cold-cathode tube light up.

21. The driving method of claim 16, wherein said load is a cold-cathode tube inverter which makes a cold-cathode tube light up.

22. The driving method of claim 17, wherein said load is a cold-cathode tube inverter which makes a cold-cathode tube light up.

23. The driving method of claim 14, wherein:
sequential drive of each of said loads is controlled by drive timing, and each of said loads is delayed by a predetermined time to be driven in sequence by means of the drive timing which is generated; and
said process that detects abnormality of each of said loads detects abnormality of each of said loads so as to match with the sequential drive delayed by the predetermined time.

24. The driving method of claim 15, wherein said process that detects abnormality of each of said loads detects a current of said loads by converting into a voltage.

25. The driving method of claim 16, wherein said process that detects abnormality of each of said loads detects a current of said loads by converting into a voltage.

26. The driving method of claim 14, wherein:
the drive of each of said loads can be performed at the same time by means of the time division; and
abnormality of each of said loads is detected in case in which said loads are driven in sequence.
